(19) United States
(12) Patent Application Publication
(10) Pub. No.: US 2017/0099830 A1
(43) Pub. Date: Apr. 13, 2017

(54) NESTING LADDER ASSEMBLY AND METHODS

(71) Applicant: Hunt Strategy, LLC, Frankenmuth, MI (US)

(72) Inventor: Scott D. Lee, Vassar, MI (US)

(73) Assignee: Hunt Strategy, LLC, Frankenmuth, MI (US)

(21) Appl. No.: 14/882,305

(22) Filed: Oct. 13, 2015

(51) Int. Cl. A01M 31/02

(52) U.S. Cl. CPC A01M 31/02

(57) ABSTRACT

A nestable ladder tree stand assembly is shown that may be used for hunting from an elevated position. The ladder tree stand includes a platform that may support a hunter and may be attached to the elevated position. First and second ladder segments are also included, with one of the ladder segments being connectable to the platform. Each ladder segment includes two support pillars that have top ends spaced apart at a first distance and that have bottom ends spaced apart at a second distance that is different from the first distance. At least one horizontal support beam extends between the support pillars. The first distance of a second ladder segment is substantially equal to the second distance of a first ladder segment, and the bottom ends of the support pillars of the first ladder segment are connectable to the top ends of the support pillars of the second ladder segment.

### TECHNICAL FIELD

The present disclosure generally relates to a ladder assembly commonly used in hunting and other outdoor activities to elevate and support a person above the ground and specifically relates to a tapering tree stand having segments capable of being nested while stored or carried.

### BACKGROUND

A tree stand is a platform attachable to a tree or other tall or elevated position to which a hunter or other outdoorsman can climb in order to improve his vantage point relative to surrounding terrain and game animals. As will be readily appreciated by skilled hunters, tree stands may be positioned in remote wooded areas and may be camouflaged in order to await the approach of game animals and shoot at them from above. Hunters may have to wait for the arrival of suitable animals for extended periods of time, so it is important for the hunter to be safely and comfortably secured in the tree stand while ensuring ease of striking at his target when the proper moment arrives.

Ladder tree stands are popular among those desiring improved safety and convenience in ascending and descending a tree stand. A ladder tree stand is a type of tree stand that includes a ladder that extends from the support platform to the ground. The hunter transports component parts of the ladder along with the platform to the location of the tree stand and assembles the platform and the ladder in the field.

A great deal of effort is expended to prepare to use a tree stand. The hunter must carefully choose the position of the tree stand, including factoring in its distance from camping areas, water sources, wildlife trails, or other nearby points of interest. Because the position of the tree stand is often in a remote area, the tree stand must usually be carried over rough terrain and over a considerable distance before it is set up.

Conventional tree stands are bulky and therefore are usually difficult to move into position. This is especially the case for ladder tree stands because the large and sturdy ladder portions must be moved in addition to the platform. The size of ladder tree stands is therefore one of their most significant drawbacks and one reason why they are not always used, even when their convenience (once assembled) would be advantageous. Their size is also detrimental to manufacturers, distributors, retailers, and consumers, since the volume of the ladder tree stand increases the size of packaging and storage space used by each tree stand. There is therefore a need for improvements to ladder tree stands.

### SUMMARY

One aspect of the present disclosure relates to a ladder assembly. The ladder assembly may comprise a first ladder segment and a second ladder segment. The first and second ladder segments may each comprise a first support pillar and a second support pillar, with each of the support pillars having a top end and a bottom end, the top ends of the first and second support pillars being spaced apart at a first distance and the bottom ends of the first and second support pillars are spaced apart at a second distance, and the first distance being different from the second distance. The segments may also include at least one horizontal support beam extending between the first and second support pillars. The first distance of the second ladder segment may be substantially equal to the second distance of the first ladder segment, and the bottom ends of the support pillars of the first ladder segment may be connectable to the top ends of the support pillars of the second ladder segment.

In some embodiments, the support pillars of the second ladder segment may be spaced apart sufficient to receive the support pillars of the first ladder segment between the support pillars of the second ladder segment. A horizontal beam of the second ladder segment may abut a horizontal beam of the first ladder segment when the support pillars of the first ladder segment are received between the support pillars of the second ladder segment. The support pillars of the first and second ladder segments may have an equal pillar depth, and the horizontal support beams of the first and second ladder segments have an equal beam depth, wherein the support pillars of the first ladder segment are positionable adjacent to the support pillars of the second ladder segment such that a total thickness of the ladder segments is equal to the pillar depth plus the beam depth.

In some arrangements the at least one horizontal support beam of the first ladder segment has a first width that differs from a second width of the at least one horizontal support beam of the second ladder segment. The ladder assembly may also further comprise a third ladder segment, which comprises a first support pillar and a second support pillar, with each of the support pillars having a top end and a bottom end, the top ends of the first and second support pillars being spaced apart at a first distance and the bottom ends of the first and second support pillars are spaced apart at a second distance, and the first distance being different from the second distance. The segment may also have at least one horizontal support beam extending between the first and second support pillars. The first distance of the third ladder segment may be substantially equal to the second distance of the second ladder segment, and the bottom ends of the support pillars of the second ladder segment may be connectable to the top ends of the support pillars of the second ladder segment. At least one of the second and third ladder segments may be attachable to an elevated support surface.

In additional embodiments, the support pillars of the first and second ladder segments may taper upward when the ladder is assembled. The first distance may be less than the second distance for each ladder segment. In some embodiments, the ladder assembly may include a platform that is attachable to an elevated support surface and may support a hunter when attached to the elevated support surface. At least one of the first and second ladder segments may be connectable to the platform.

Another aspect of the disclosure relates to a ladder assembly, wherein the ladder assembly comprises a first ladder segment, and a second ladder segment. The first and second ladder segments may each comprise a pair of vertical pillar supports and at least one horizontal support. In a first position, the pair of vertical pillar supports of the first ladder segment may be configured to fit between the pair of vertical pillar supports of the second ladder segment, and in a second position, the pairs of vertical pillar supports may be configured to connect to each other end-to-end.

The first and second ladder segments may taper upward in the first and second positions. One of the first and second ladder segments may be a base segment, wherein the base segment has a bottom end wider than a top end of the base segment. At least one of the first and second ladder segments may be laterally attachable to a tree or elevated support surface. In some embodiments the vertical pillar supports of the first ladder segment are insertable into the vertical pillar supports of the second ladder segment.

Another aspect of the disclosure relates to a method of constructing a ladder, with the method comprising providing a first ladder segment and a second ladder segment. The first and second ladder segments may each comprise a pair of vertical pillars and a horizontal beam, with each horizontal beam connecting each pair of vertical pillars to each other, the pair of vertical pillars each having top ends and bottom ends, and the top ends being spaced apart differently from the bottom ends. The method may further include connecting the bottom ends of the pair of vertical pillars of the first ladder segment to the top ends of the pair of vertical pillars of the second ladder segment.

In some configurations, the method may include connecting the first ladder segment to a platform, attaching the platform to an elevated support surface, and linking bottom ends of the pair of vertical pillars of the second ladder segment to a ground surface. Linking the bottom ends of the second ladder segment to the ground surface may also comprise connecting the bottom ends to top ends of a pair of vertical pillars of a third ladder segment that is linked to the ground surface. In some cases, connecting the bottom ends of the pair of vertical pillars of the first ladder segment to the top ends of the pair of vertical pillars of the second ladder segment comprises the top ends of the second ladder segment receiving the bottom ends of the first ladder segment or the bottom ends of the first ladder segment receiving the top ends of the second ladder segment.

In another aspect of the disclosure, a method of assembling a ladder is set forth. The method may include providing a first ladder segment and a second ladder segment. The first and second ladder segments may each comprise a pair of elongated pillars and a foothold beam, with each foothold beam connecting each pair of elongated pillars to each other, the pair of elongated pillars each having top ends and bottom ends, and the top ends being spaced apart more closely than the bottom ends. The method may also include positioning the elongated pillars of the first ladder segment between the elongated pillars of the second ladder segment such that the top ends of the first and second ladder segments are adjacent to each other and the bottom ends of the first and second ladder segments are adjacent to each other.

This method may also comprise positioning the foothold beams of the first and second ladder segments adjacent to each other when the elongated pillars of the first ladder segment are positioned between the elongated pillars of the second ladder segment. In another embodiment the method may include inserting the foothold beam of the second ladder segment through a space between the elongated pillars of the second ladder segment. In yet another embodiment the method may further comprise lifting the first and second ladder segments by lifting one of the foothold beams. The method may further comprise connecting a platform to at least one of the first and second ladder segments, the platform being configured to support a hunter when attached to an elevated position.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a perspective view of a ladder tree stand of the present disclosure attached to a support.

FIG. 2 is a side view of the ladder tree stand of FIG. 1.

FIG. 3 is a front view of the ladder tree stand of FIG. 1.

FIG. 4 is a top view of the ladder tree stand of FIG. 1.

FIG. 5 is an exploded view of the ladder tree stand of FIG. 1.

FIG. 6 is a detail view of connection points between two ladder segments of a ladder tree stand.

FIG. 7 is a front perspective view of a nested configuration of a ladder tree stand.

FIG. 8 is a rear perspective view of the nested configuration of FIG. 7.

FIG. 9 is a front view of the nested configuration of FIG. 7.

FIG. 10 is a side view of the nested configuration of FIG. 7.

FIG. 11 is a front view of the ladder segments of the nested configuration of FIG. 7.

FIG. 12 is a back view of the ladder segments of FIG. 11.

FIG. 13 is a side view of the ladder segments of FIG. 11.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Aspects of the present disclosure relate to a ladder tree stand that has ladder segments, platform parts, and supports that can be disassembled and nested together in a compact space for storage and transportation yet can provide ample support to bear a hunter or other outdoorsperson when implemented in the field. One embodiment of the ladder tree stand is an assembly that includes a platform that is configured to horizontally attach to an elevated position and to support the hunter in the elevated position. The platform may comprise multiple sections, such as, for example, steps, seats, footholds, handholds, jaws for attachment to a tree, etc., to provide support where needed for the user and to attach to one or more portions of a tree, rock face, post, or other elevated attachment point.

The tree stand assembly may also have first and second ladder segments, at least one of which is attachable or connectable to the platform. The ladder segments may attach or connect to the platform and to each other using fasteners, a friction fit, or other connection devices and mechanisms that will be known to those having skill in the art. Thus, “connecting” segments may comprise inserting a portion of a segment into another segment, and may also potentially include attaching a fastener to the segments to keep them together.

Each ladder segment may comprise at least two support pillars that are configured to be positioned vertically when the tree stand is assembled. Their vertical positions may be generally vertical but may also be tilted or angled to a small degree. However, ends of the support pillars may be straight and parallel to ease assembly of one ladder segment with another.

The support pillars may have ends that are differently spaced in each ladder segment. For example, one ladder segment may have top ends of its support pillars that are spaced more narrowly or more closely than bottom ends of its support pillars, and a second ladder segment may have support pillar top ends that are spaced similarly to the bottom ends of the first ladder segment, but may have support pillar bottom ends that are spaced more widely than its top ends. The top of one ladder segment may connect to the bottom of another ladder segment so that an elongated ladder may be assembled from the ladder segments. In this manner, when the ladder segments are assembled into a ladder, the bottom of the ladder may be wider than the top of the ladder (at least with respect to the support pillars). Typically, the distance between the support pillars may taper from the bottom to the top of the ladder. In some embodiments there may be a step or other transition between the bottom and top ends of each segment that changes the spacing between the ends of the support pillars so that the width between the support pillars narrows at each step or other transition.

Each ladder segment may also have at least one horizontal support beam that extends across and connects to the support pillars. The horizontal support beam may provide structural stability to the ladder segment and, in some cases, may be used as a foothold or step of the ladder when the tree stand has been assembled. In an example embodiment, there are three horizontal support beams for each ladder segment.

When the ladder is disassembled, the tapered or stepped support pillars may be positioned relative to each other such that the support pillars of one ladder segment fit between the next largest ladder segment in a nested configuration. Multiple ladder segments may thereby be nested and fit within a small volume. This volume of the nested ladder may typically be no thicker than the thickness of the support pillars and the horizontal support beams and may be no wider than the width of the widest ladder segment. Accordingly, a long ladder may be disassembled and nested together for easier transportation, storage, shipping, etc.

Additionally, the different sizes of each of the ladder segments may help the user to assemble the ladder or nest the ladder more easily since the ladder segments may only fit into each other in one configuration. In other words, a certain ladder segment may have a top end that only connects to the bottom end of one other segment, so the user will not be able to mistakenly assemble those segments in the wrong order or connect them to another incorrect segment. Likewise, only one ladder segment in one orientation may properly nest within the next-largest ladder segment, so the segments may be nested simply and quickly.

When the ladder segments are approximated and nested, horizontal support beams may be placed adjacent to each other. Each of the support beams may have different widths so as to fit between the widths of the support pillars of larger ladder segments. In one embodiment, the ladder of the nested tree stand may be lifted by lifting one of the support beams due to the other support beams being stacked on top of it.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

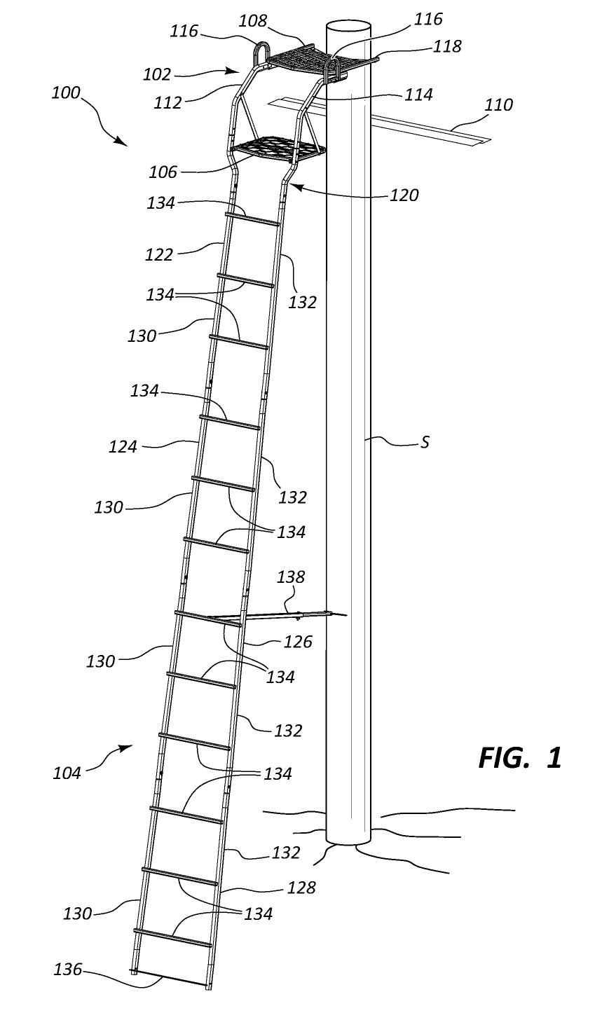

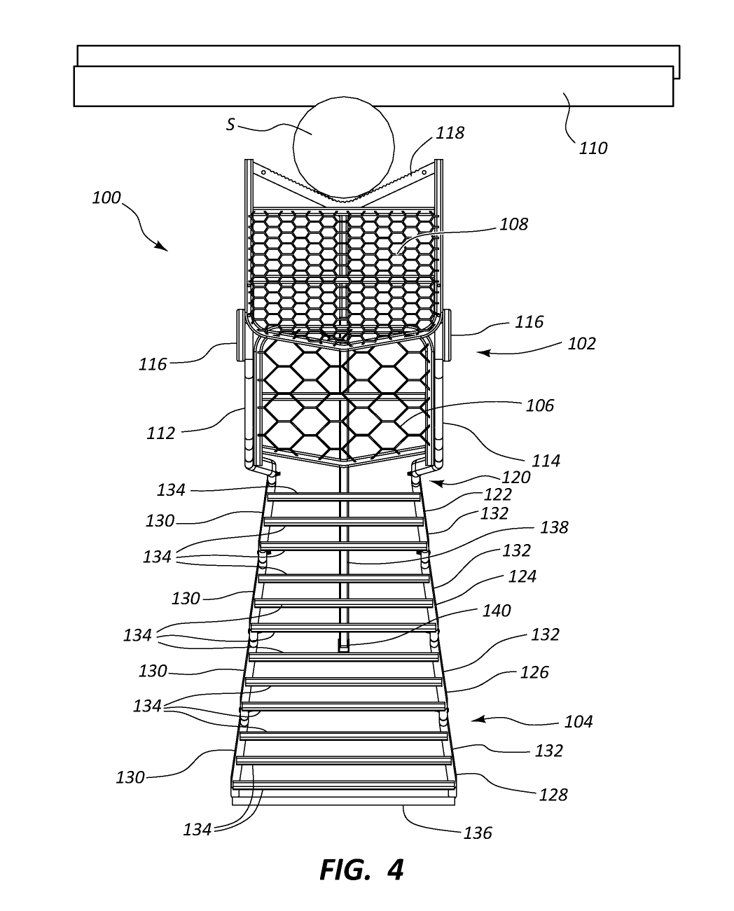

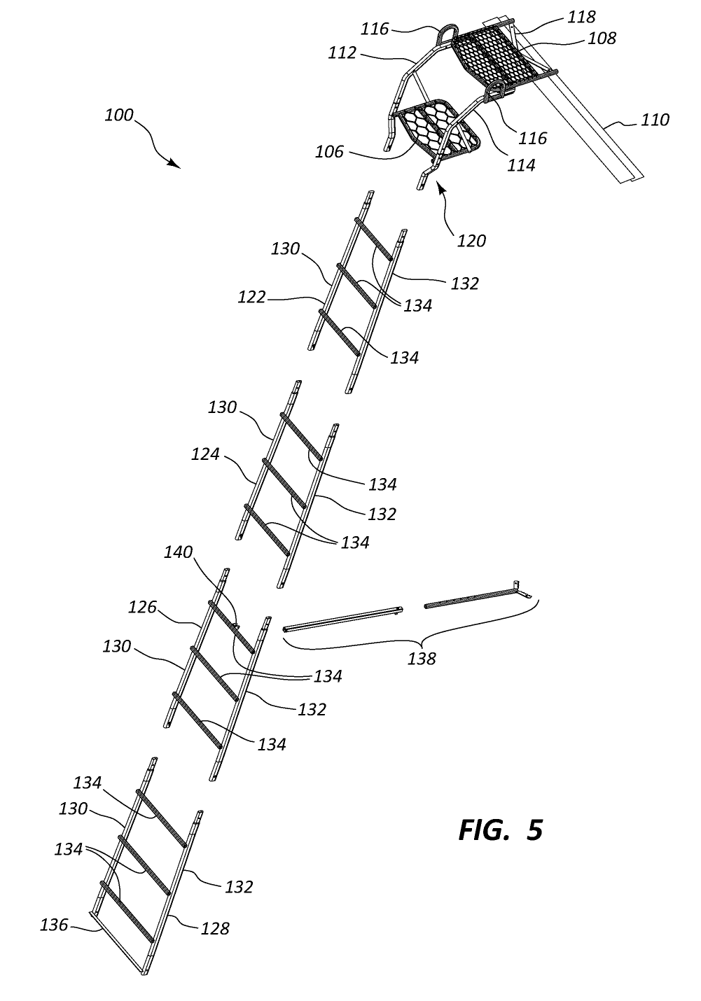

Referring now to FIGS. 1-4, a ladder tree stand 100 of the present disclosure is shown assembled and connected to a support S. FIG. 5 shows an exploded view of the tree stand 100. The tree stand 100 may comprise a platform portion 102 and a ladder 104. The platform portion 102 may comprise a first platform 106, a second platform 108, and a third platform 110, each of which is configured to be horizontal upon connection to the support S. These platforms 106, 108, 110 may support the user and/or his or her equipment once he or she has scaled the ladder 104. The first and second platforms 106, 108 may have a mesh-like or net-like surface (see FIG. 4) that allows water, mud, and other small debris to fall through the platforms 106, 108 and makes the platform portion 102 lighter and easier to move. The second platform 108 may have a smaller, tighter mesh surface than the first platform 106 in order to make it more comfortable to sit on.

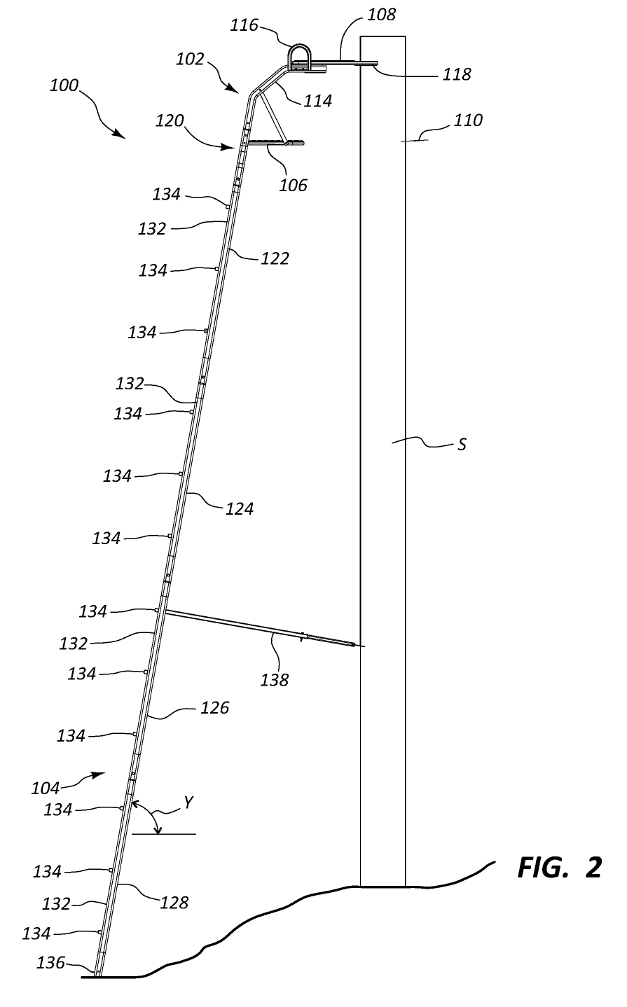

The first and second platforms 106, 108 may be connected to each other by left and right frame members 112, 114. These frame members 112, 114 may also connect to handholds 116. The first platform 106 may be suspended from the frame members 112, 114 at a position configured to be vertically lower and horizontally displaced away from the support S in relation to the second platform 108 when the platform portion 102 is attached to the support S. See FIG. 2. As shown in FIG. 2, the inner angle Y between the ladder 104 and a horizontal direction may be configured to be between about 70 degrees and about 90 degrees. The second platform 108 may connect to the support S (e.g., a tree trunk) using a grip 118 such as, for example, a spiked brace or another attachment device known in the art. The third platform 110 may fit against the support S opposite the second platform 108, such as, for example, by being driven at least partially into the support S or by being attached to the support S by fasteners.

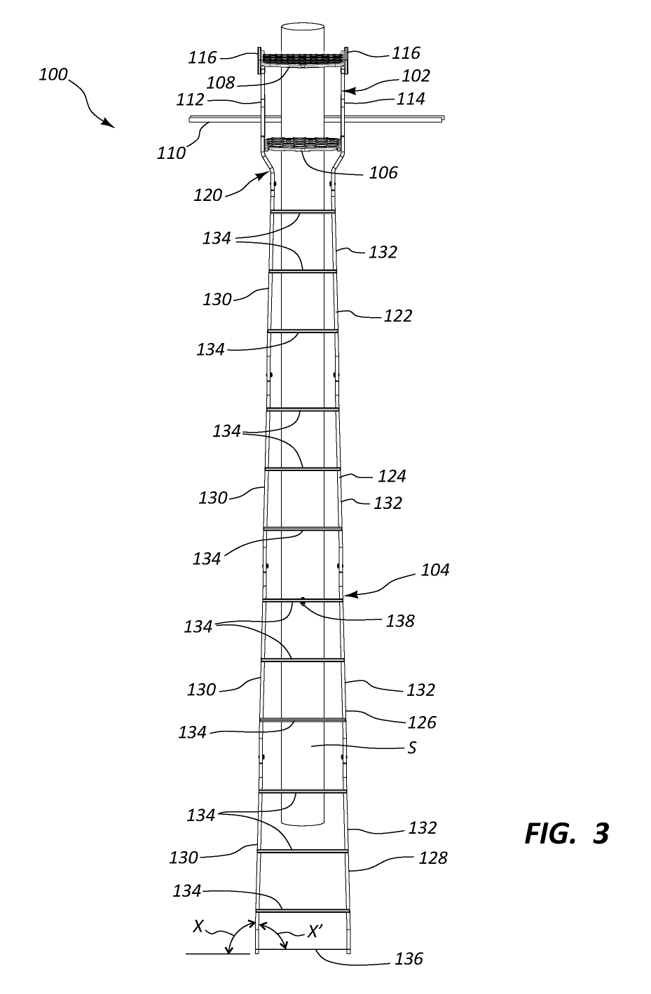

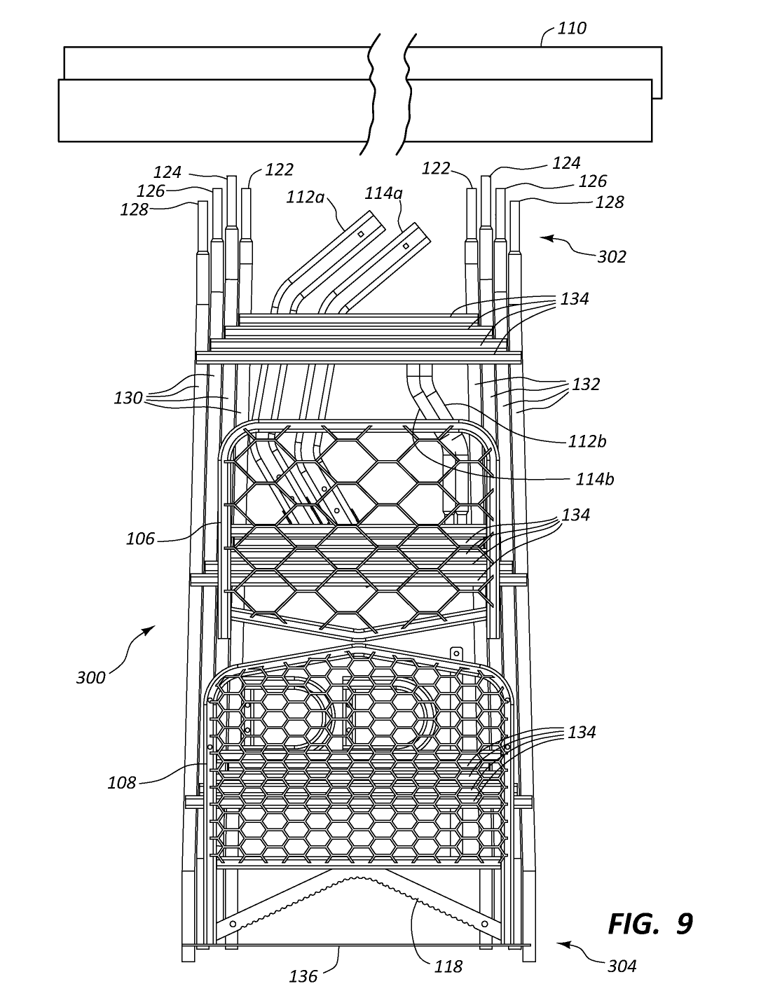

The platform portion 102 may comprise a bottom end 120 configured to connect to the ladder 104. The bottom end 120 may include the bottom ends of the left and right frame members 112, 114, and the ladder 104 may be inserted or connected by fasteners or other connecting devices to the bottom end 120 at the bottom ends of the frame members 112, 114. The bottom of the left and right frame members 112, 114 may be spaced apart more closely at the bottom end 120 of the platform portion 102 than at the first or second platforms 106, 108. This may allow the first and second platforms 106, 108 to have a greater width than the top of the ladder 104 and may allow the ladder 104 to narrow from bottom to top without the platforms 106, 108 taking up substantially more width than the bottom of the ladder 104. See also FIG. 9 which shows the relative widths of the ladder segments 122, 124, 126, 128 and the platforms 106, 108. Additionally, the second platform 108 may be wider than the first platform 106. See FIGS. 3-4 and 9.

The ladder 104 may comprise at least four ladder segments 122, 124, 126, 128, each of which may have left and right support pillars 130, 132 and a plurality of horizontal support beams 134. In this embodiment, there are three horizontal support beams 134 per ladder segment, but in other embodiments there may be more or fewer beams 134 per segment, and in some embodiments there may be different numbers of beams 134 per segment. For example, the bottom ladder segment 128 of the ladder 104 includes a stabilization bar 136 which may be considered an additional horizontal support beam, although it is not meant to be used as a foothold.

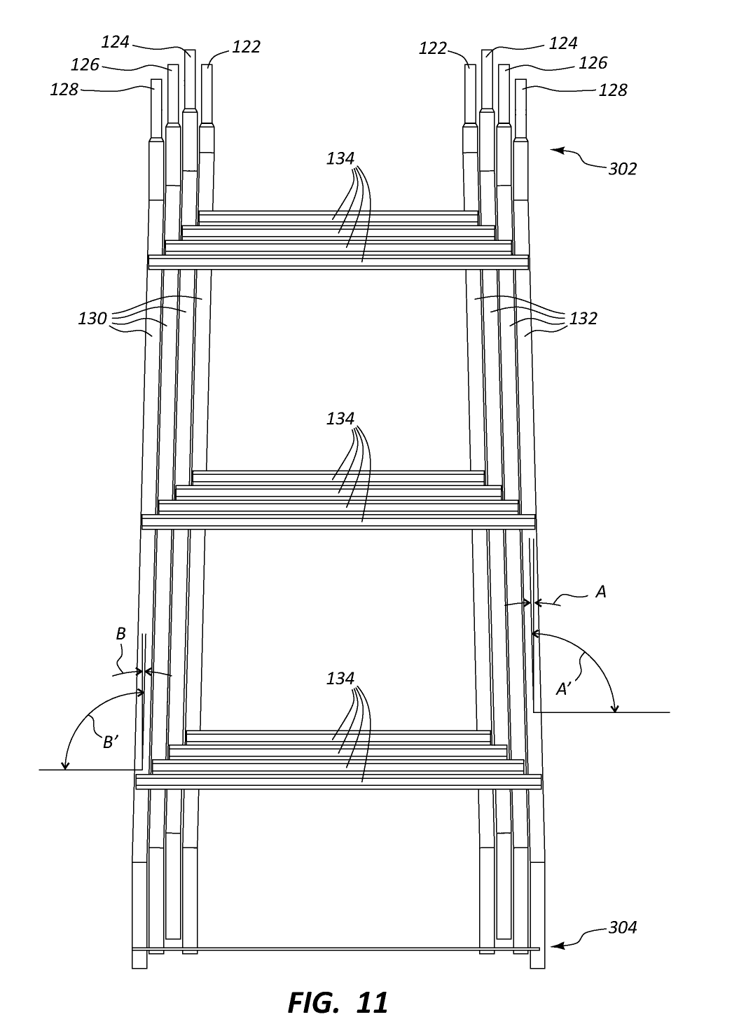

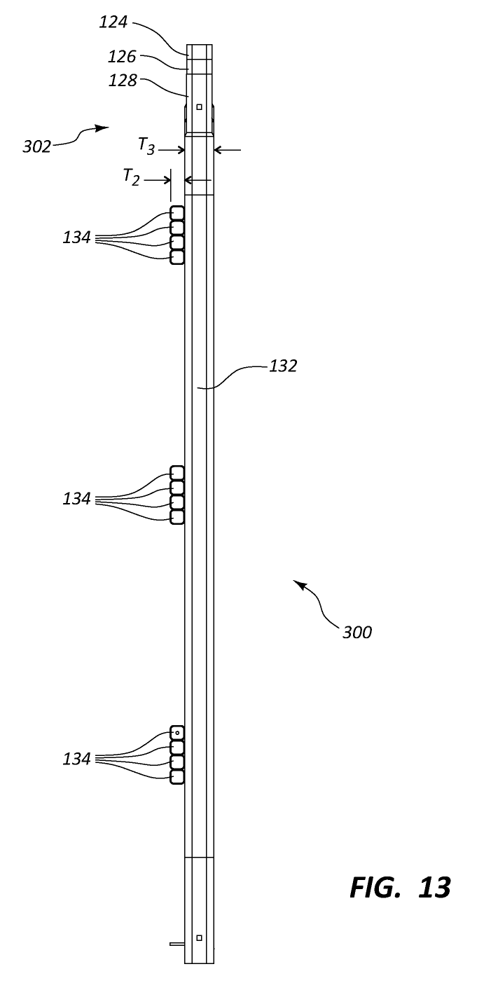

The bottom ladder segment 128 may be connected to a ground surface by resting the bottom ends of its support pillars 130, 132 on a ground surface. The next-lowest ladder segment 126 may be connected to a ground surface by connection to ladder segment 128 which is resting on the ground. The next ladder segment 124 may be connected to a ground surface by connection to ladder segments 126 and 128. The horizontal support beams 134 may be sized and spaced along each ladder segment 122, 124, 126, 128 in order to provide a generally even spacing of the beams 134 upon assembly of the ladder 104. Thus, the beams 134 may be spread in a manner corresponding with a distance between steps or rungs of a ladder that a normal person would be able to comfortably ascend and descend. The thickness T₂ (see FIG. 13) of the beams 134 may be sufficient to provide stable footing for a climbing user. The width of the beams 134 may be approximately equal to the width across the left and right support pillars 130, 132 such that each of the support beams 134 may have a different width. See, e.g., FIGS. 4 and 11. In other embodiments, multiple support beams 134 may have the same width or may have a width greater than the distance between the left and right support pillars 130, 132.

The width between the support pillars 130, 132 of the ladder segments 122, 124, 126, 128 may taper and narrow leading up to the bottom end 120 of the platform portion 102. To this end, each ladder segment 122, 124, 126, 128 may have a top width between support pillars 130, 132 that corresponds to a bottom width between support pillars 130, 132 of the next higher ladder segment. This also means that the ladder segments 122, 124, 126, 128 may not connect to each other out of order, so assembly of the ladder may be simplified. The top ladder segment (e.g., 122) may have a top width configured to attach to the bottom end 120 of the platform portion 102. In some embodiments, the taper of the ladder segments may be defined as an angle formed between a support pillar and a horizontal direction when the ladder segment is upright. For example, as shown in FIG. 3, the outer angle X between a support pillar 130 and a horizontal direction may be greater than 90 degrees. The outer angle X may be defined as being between about 90.1 degrees and about 100 degrees. This may also be the case with support pillar 132, or support pillar 132 may be constructed with a 90-degree outer angle. See also FIG. 11 and angles A′ and B′, described below. In some configurations, the inner angle X′ between the support pillar 130 and the horizontal direction may be less than 90 degrees, such as an inner angle X′ being between about 80 degrees and about 89.9 degrees. Similarly, the inner angle between support pillar 132 may be within this range, or may be a 90-degree angle.

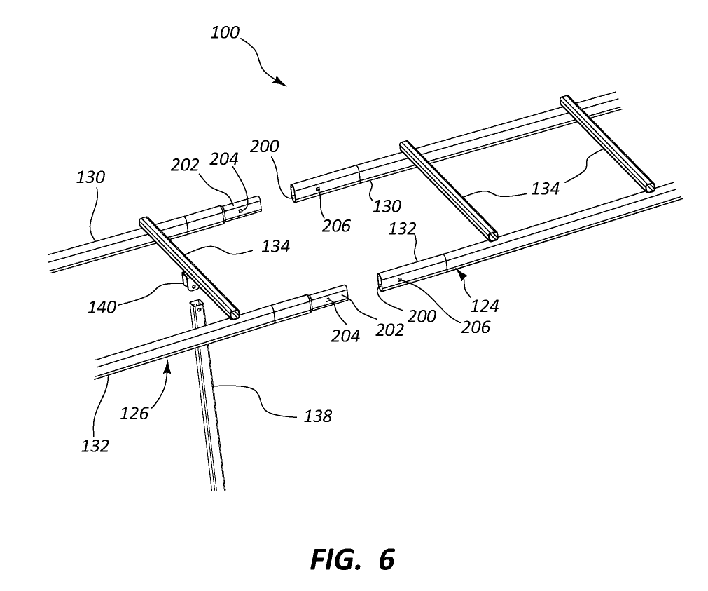

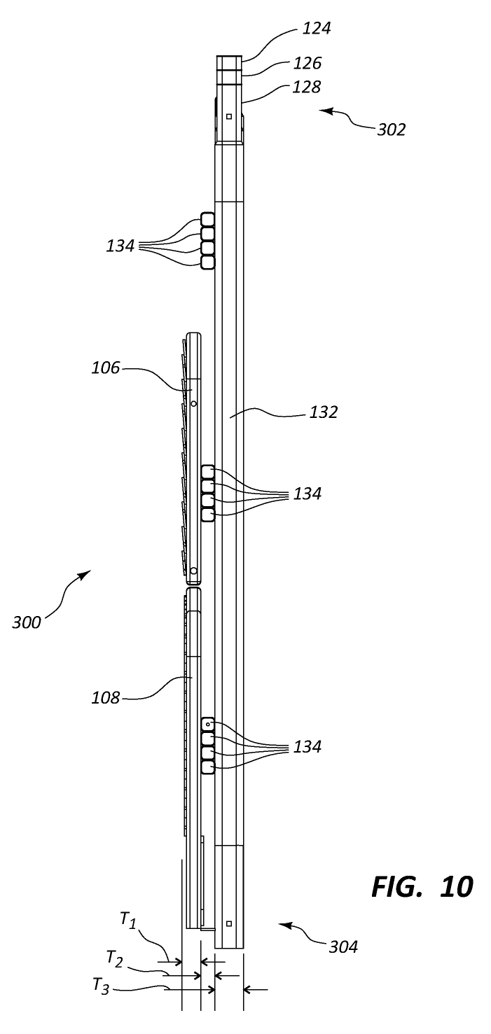

In these embodiments, the support beams 134 have a generally tubular construction (see FIGS. 6 and 10) that decreases weight while providing a stable width for foot support. The tubular shape may be generally rectangular or square to maximize the surface area of the beams 134 that contacts the support pillars 130, 132 of each ladder segment 122, 124, 126, 128 and to provide a flat contact surface for foot support. In other embodiments, the tubular cross section may be triangular, circular, or an oval shape.

The support pillars 130, 132 of each ladder segment 122, 124, 126, 128 may also may have a tubular construction that reduces weight and provides stability. As shown in FIG. 6, which is a detailed exploded view of two ladder segments 124, 126, the support pillars 130, 132 of the upper ladder segment 124 may comprise openings 200 configured to receive necked down portions 202 of the upper ends of the support pillars 130, 132 of the lower ladder segment 126. Thus, the necked down top ends of the support pillars 130, 132 of the lower ladder segment 126 may be inserted into and received by the openings 200 of the upper ladder segment 124 when the ladder 104 is assembled. Corresponding apertures 204, 206 in the support pillars 130, 132 may align when the ends are mated, and fasteners or pins may be inserted through the apertures 204, 206 that keep the ladder segments 124, 126 from inadvertently disconnecting from each other.

FIG. 6 also shows that the cross section of the tubular shape of the support pillars 130, 132 may be an elongated oval shape or a shape having two parallel sides connected by curved ends. This cross-section may be implemented across the support pillars 130, 132 of all of the ladder segments 122, 124, 126, 128 and may provide improved resistance to bending in a direction extending toward or away from the support S.

Referring again to FIGS. 1-6, the ladder tree stand 100 may also comprise a lateral support bar 138. The lateral support bar 138 may be attachable to a support beam 134 or support pillar 130, 132 of one of the ladder segments 122, 124, 126, 128. In these figures, the lateral support bar 138 is attachable to ladder segment 126 at a bracket 140 on a support beam 134 shown in FIGS. 4-6. The lateral support bar 138 may be used to further stabilize the ladder 104 relative to the support S by extending laterally between the ladder 104 and the support S. The lateral support bar 138 may have a telescoping design so that the user can vary the angle of the ladder 104 relative to the ground and/or support S by extending or retracting the length of the lateral support bar 138.

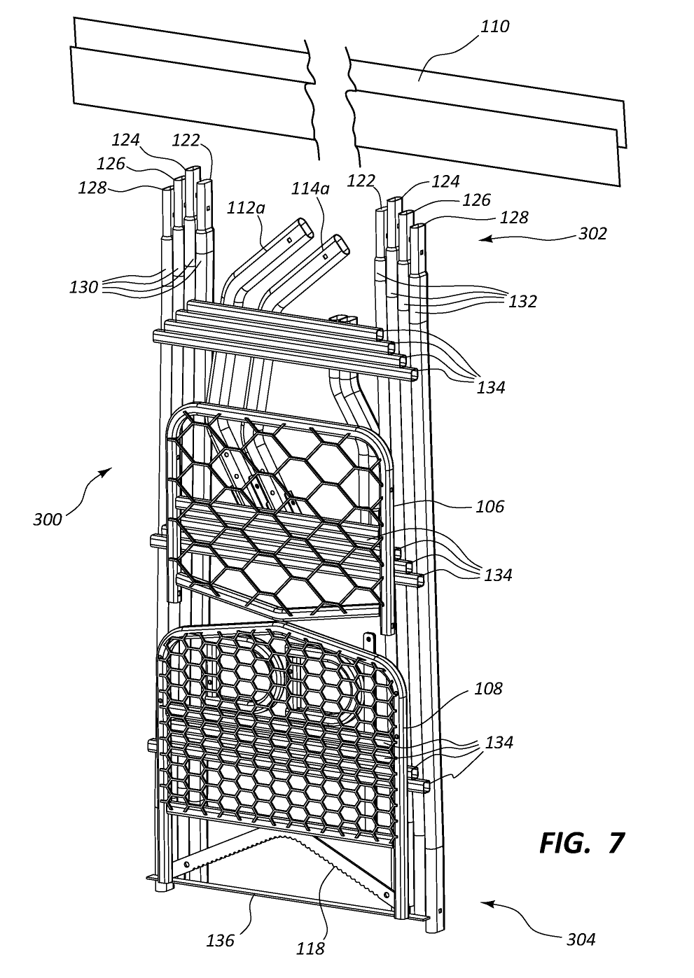

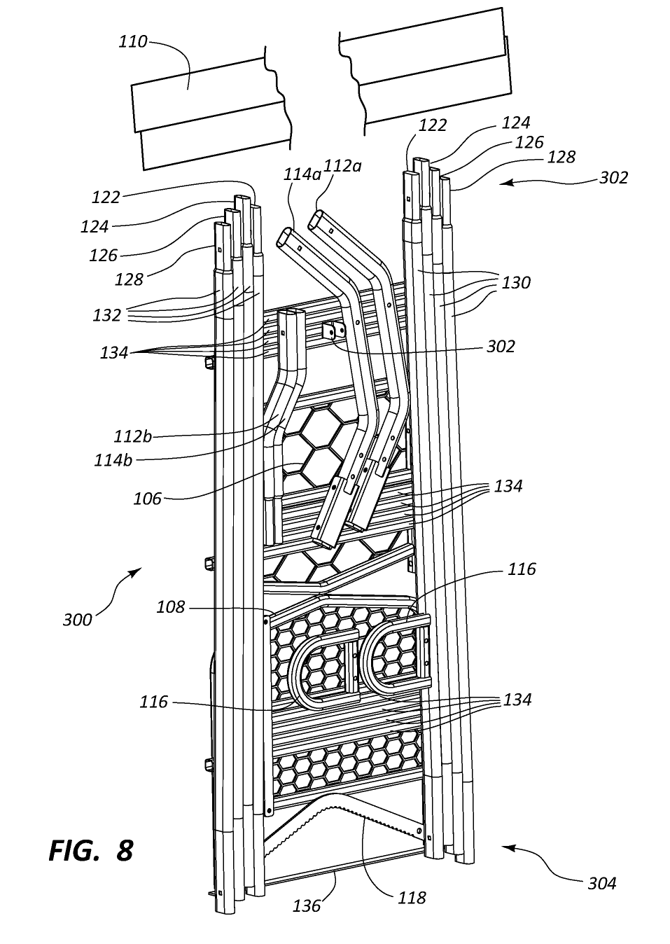

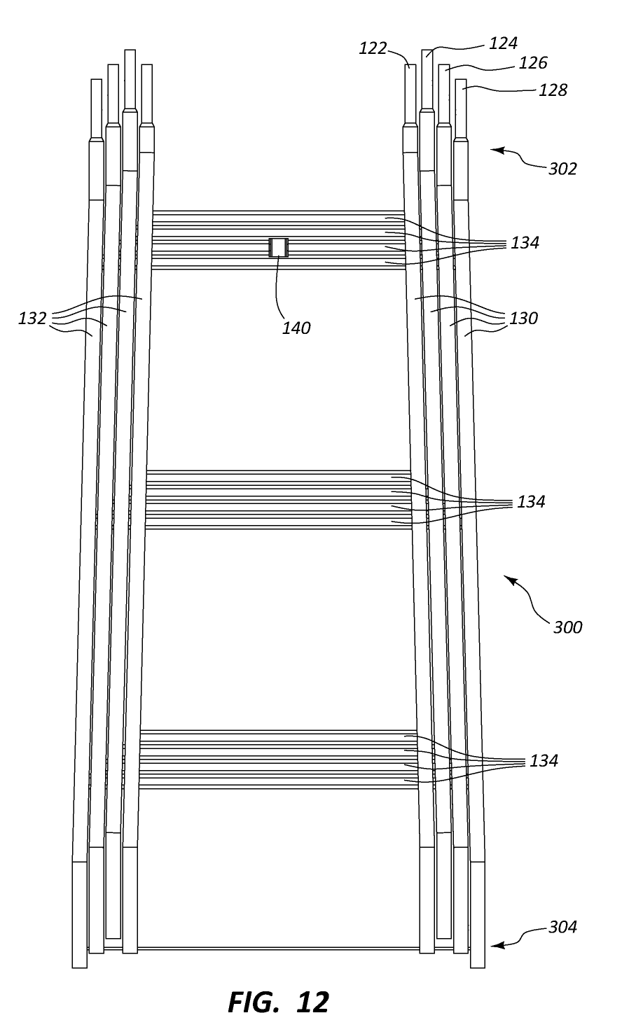

FIGS. 7-10 show various views of the ladder tree stand 100 of FIGS. 1-6 in a nested configuration 300 that may be used for applications such as, for example, transportation and/or packaging. FIG. 7 shows a perspective front view, FIG. 8 shows a perspective rear view, FIG. 9 shows a front view, and FIG. 10 shows a side view. FIGS. 11-13 show the nested configuration 300 with only the ladder segments 122, 124, 126, 128 visible. FIG. 11 is a front view, FIG. 12 is a rear view, and FIG. 13 is a side view.

As shown in FIGS. 7-13, the ladder segments 122, 124, 126, 128 may be nested relative to each other, with the widest ladder segment 128 at the outermost position and the narrowest ladder segment 122 at the centermost position. In other words, the widest segment 128 may have its left and right support pillars 130, 132 external to the left and right support pillars 130, 132 of the next-widest segment 126, which, in turn, is external to the pillars 130, 132 of the following segment 124, which itself is external to the pillars 130, 132 of the narrowest segment 122. Said another way, larger or wider ladder segments may be configured to receive smaller or narrower segments sequentially or between the support pillars 130, 132 of each other.

The ladder segments 122, 124, 126, 128 may be configured to be nestable with the top ends 302 of their support pillars 130, 132 being adjacent to each other and the bottom ends 304 of their support pillars 130, 132 being adjacent to each other. This is the case, in part, because the support pillars 130, 132 may be non-parallel (i.e., may form an angle relative to a vertical direction) when positioned upright. FIG. 11 shows angles A and B which are the angles between a vertical direction and a longitudinal axis of the outermost right support pillar 132 and the outermost left support pillar 130 of the nested configuration 300, respectively. Angles A′ and B′ are angles between the longitudinal axes of the support pillars 130, 132 and a horizontal direction. Angles A and B are non-zero, and angles A′ and B′ are not right angles. The left and right support pillars 130, 132 of the rest of the ladder segments 122, 124, 126 may also form non-zero angles (e.g., A and B) relative to the vertical direction. Thus, the width between the support pillars 130, 132 of each ladder segment 122, 124, 126, 128 narrows from their bottom ends 304 to their top ends 302. The bottom ends 304 of the second-widest segment 126 does not fit between the top ends 302 of the widest segment 128 (or any other segment). This means there is only one configuration in which all of the ladder segments 122, 124, 126, 128 may be nested, one within another, so that rearranging the nested configuration after disassembly of the ladder tree stand 100 is straightforward.

The top ends 302 and bottom ends 304 of the support pillars 130, 132 may have straight, parallel portions where they are configured to connect, end-to-end, to other ladder segments, the platform portion 102, or the ground. Thus, portions of the support pillars 130, 132 may be non-parallel and other portions may be parallel (e.g., at the ends 302, 304). This may help ease the insertion and removal of the tips of the support pillars 130, 132 when the ladder segments 122, 124, 126, 128 are assembled and disassembled. The straight end portions produce visible discontinuities in the direction of the pillars 130, 132 of the ladder 104, as shown in FIG. 4. In other embodiments, the pillars 130, 132 may not have parallel portions and therefore may not have these discontinuities.

The horizontal support beams 134 of the ladder 104 are also shown in FIGS. 7-13. The horizontal support beams 134 may be positioned adjacent and parallel to each other when the ladder tree stand 100 is in the nested configuration 300. In some configurations, the beams 134 may abut each other and limit movement of each other in one direction. In order to bring the beams 134 into the nested configuration 300, the beams 134 may be inserted through the space between the left and right support pillars 130, 132. The nested configuration 300 may also have groups of support beams 134 that are vertically separated from each other (e.g., three groups of four in these figures). In this embodiment, the support beams 134 are positioned with the narrowest support beams 134 (which correspond with the narrowest ladder segment 122) at the top and the widest support beams 134 (which correspond with the widest ladder segment 128) at the bottom, with the other support beams 134 in between. Because the support beams 134 are adjacent to each other, a user may lift the entire ladder 104 by grasping the widest support beam 134 in one of the groups of four support beams 134 (e.g., above the platform 106 in FIG. 7) and lift the ladder 104 by the support beams 134 without the ladder segments 122, 124, 126, 128 falling out of their nested configuration 300.

Aside from the ladder 104, the rest of the ladder tree stand 100 components may be attached to the ladder segments 122, 124, 126, 128 in the nested configuration 300 to compactly transport the ladder tree stand 100. For example, the platforms 106, 108 may be connected to the front of the support beams 134 and the handholds 116 may be connected between left and right support pillars 130, 132. The left and right frame members 112, 114 may be disassembled into upper frame members 112a, 114a and lower frame members 112b, 114b that also fit between the support pillars 130, 132. The third platform 110 may fit between the ladder 104 and other components (e.g., the platforms 106, 108). When in the nested configuration 300, the entire ladder tree stand 100 (minus the third platform 110, potentially) may have a width no greater than the width of the widest ladder segment 128, as shown in FIG. 9, and may have a depth no greater than the combined thicknesses of the platform 106 (i.e., T₁, the “platform depth”), the support beams 134 (i.e., T₂, the “beam depth”), and the support pillars 130, 132 (i.e., T₃, the “pillar depth”), as shown in FIG. 10. This means the tree stand 100 is exceptionally compact and requires drastically reduced storage volume as compared to typical ladder tree stands. The ladder segments, by themselves, have a thickness of just T₂ plus T₃, as shown in FIG. 13.

Another aspect of the disclosure relates to methods for constructing a ladder tree stand for hunting from an elevated position. In one embodiment, the method may comprise providing a platform configured to horizontally attach to an elevated position and to support a hunter when attached to the elevated position and providing a first ladder segment and a second ladder segment, wherein the first and second ladder segments each comprise a pair of vertical pillars and a horizontal beam. Each horizontal beam may connect each pair of vertical pillars to each other. The pair of vertical pillars may each have top and bottom ends, with the top ends being spaced apart more closely than the bottom ends.

The method may further include connecting the first ladder segment to the platform, connecting the bottom ends of the pair of vertical pillars of the first ladder segment to the top ends of the pair of vertical pillars of the second ladder segment, attaching the platform to a tree or earthen surface, and linking bottom ends of the pair of vertical pillars of the second ladder segment to a ground surface.

In some embodiments, linking the bottom surface to the ground surface may comprise resting the bottom ends on the ground surface. In other cases, linking to the ground surface may comprise connecting the bottom ends to top ends of a pair of vertical pillars of a third ladder segment (i.e., one or more linked ladder segments) that is linked to the ground surface. Connecting the bottom ends of the pair of vertical pillars of the first ladder segment to the top ends of the pair of vertical pillars of the second ladder segment may comprise the top ends of the second ladder segment receiving the bottom ends of the first ladder segment or the bottom ends of the first ladder segment receiving the top ends of the second ladder segment.

Another aspect of the present disclosure relates to methods of assembling a ladder tree stand which may include providing a first ladder segment and a second ladder segment, the first and second ladder segments each comprising a pair of elongated pillars and a foothold beam that connects the pair of elongated pillars. The pair of pillars may have top ends more closely spaced apart than their bottom ends. The method may further include positioning the pillars of the first ladder segment between the elongated pillars of the second segment such that the top ends of the first and second ladder segments are adjacent to each other and the bottom ends of the first and second segments are adjacent to each other. The method may also include connecting a platform to at least one of the ladder segments, wherein the platform is configured to support a hunter when the platform is attached to an elevated position.

The foothold beams of multiple ladder segments may be positioned adjacent to each other when the elongated pillars of one ladder segment are positioned between a second ladder segment. A foothold beam may be inserted through a space between the elongated pillars of the second ladder segment. The method may also include lifting the first and second ladder segments by lifting one of the foothold beams.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including” and “having” come as used in the specification and claims shall have the same meaning as the term “comprising.”

What is claimed is:

1. A ladder assembly, comprising:
a first ladder segment and a second ladder segment, the first and second ladder segments each comprising:
a first support pillar and a second support pillar, each of the support pillars having a top end and a bottom end, the top ends of the first and second support pillars being spaced apart at a first distance and the bottom ends of the first and second support pillars are spaced apart at a second distance, the first distance being different from the second distance;
at least one horizontal support beam extending between the first and second support pillars;
wherein the first distance of the second ladder segment is substantially equal to the second distance of the first ladder segment, and the bottom ends of the support pillars of the first ladder segment are connectable to the top ends of the support pillars of the second ladder segment.

2. The ladder assembly of claim 1, wherein the support pillars of the second ladder segment are spaced apart sufficient to receive the support pillars of the first ladder segment between the support pillars of the second ladder segment.

3. The ladder assembly of claim 2, wherein a horizontal beam of the second ladder segment abuts a horizontal beam of the first ladder segment when the support pillars of the first ladder segment are received between the support pillars of the second ladder segment.

4. The ladder assembly of claim 1, wherein the support pillars of the first and second ladder segments have an equal pillar depth and the horizontal support beams of the first and second ladder segments have an equal beam depth, wherein the support pillars of the first ladder segment are positionable adjacent to the support pillars of the second ladder segment such that a total thickness of the ladder segments is equal to the pillar depth plus the beam depth.

5. The ladder assembly of claim 1, wherein the at least one horizontal support beam of the first ladder segment has a first width that differs from a second width of the at least one horizontal support beam of the second ladder segment.

6. The ladder assembly of claim 1, further comprising:
a third ladder segment, comprising:
a first support pillar and a second support pillar, each of the support pillars having a top end and a bottom end, the top ends of the first and second support pillars being spaced apart at a first distance and the bottom ends of the first and second support pillars are spaced apart at a second distance, the first distance being different from the second distance;
at least one horizontal support beam extending between the first and second support pillars;
wherein the first distance of the third ladder segment is substantially equal to the second distance of the second ladder segment, and the bottom ends of the support pillars of the second ladder segment are connectable to the top ends of the support pillars of the second ladder segment.

7. The ladder assembly of claim 6, wherein at least one of the second and third ladder segments is attachable to an elevated support surface.

8. The ladder assembly of claim 1, wherein the support pillars of the first and second ladder segments taper upward when the tree stand is assembled.

9. The ladder assembly of claim 1, wherein the first distance is less than the second distance for each ladder segment.

10. The ladder assembly of claim 1, further comprising a platform, the platform being attachable an elevated support surface to support a hunter when attached to the elevated support surface, at least one of the first and second ladder segments being connectable to the platform.

11. A ladder assembly, comprising:
a first ladder segment and a second ladder segment, the first and second ladder segments each comprising a pair of vertical pillar supports and at least one horizontal support;
wherein, in a first position, the pair of vertical pillar supports of the first ladder segment are configured to fit between the pair of vertical pillar supports of the second ladder segment, and in a second position, the pairs of vertical pillar supports are configured to connect to each other end-to-end.

12. The ladder assembly of claim 11, wherein the first and second ladder segments taper upward in the first and second positions.

13. The ladder assembly of claim 11, wherein one of the first and second ladder segments is a base segment, the base segment having a bottom end wider than a top end of the base segment.

14. The ladder assembly of claim 11, wherein at least one of the first and second ladder segments is laterally attachable to a tree or elevated support surface.

15. The ladder assembly of claim 11, wherein the vertical pillar supports of the first ladder segment are insertable into the vertical pillar supports of the second ladder segment.

16. A method of constructing a ladder, the method comprising:
providing a first ladder segment and a second ladder segment, the first and second ladder segments each comprising a pair of vertical pillars and a horizontal beam, each horizontal beam connecting each pair of vertical pillars to each other, the pair of vertical pillars each having top ends and bottom ends, the top ends being spaced apart differently from the bottom ends;
connecting the bottom ends of the pair of vertical pillars of the first ladder segment to the top ends of the pair of vertical pillars of the second ladder segment.

17. The method of claim 16, further comprising connecting the first ladder segment to a platform, attaching the platform to an elevated support surface, and linking bottom ends of the pair of vertical pillars of the second ladder segment to a ground surface.

18. The method of claim 17, wherein linking the bottom ends of the second ladder segment to the ground surface comprises connecting the bottom ends to top ends of a pair of vertical pillars of a third ladder segment that is linked to the ground surface.

19. The method of claim 16, wherein connecting the bottom ends of the pair of vertical pillars of the first ladder segment to the top ends of the pair of vertical pillars of the second ladder segment comprises the top ends of the second ladder segment receiving the bottom ends of the first ladder segment or the bottom ends of the first ladder segment receiving the top ends of the second ladder segment.

20. A method of assembling a ladder, the method comprising:
providing a first ladder segment and a second ladder segment, the first and second ladder segments each comprising a pair of elongated pillars and a foothold beam, each foothold beam connecting each pair of elongated pillars to each other, the pair of elongated pillars each having top ends and bottom ends, the top ends being spaced apart more closely than the bottom ends;
positioning the elongated pillars of the first ladder segment between the elongated pillars of the second ladder segment such that the top ends of the first and second ladder segments are adjacent to each other and the bottom ends of the first and second ladder segments are adjacent to each other.

21. The method of claim 20, further comprising positioning the foothold beams of the first and second ladder segments adjacent to each other when the elongated pillars of the first ladder segment are positioned between the elongated pillars of the second ladder segment.

22. The method of claim 20, further comprising inserting the foothold beam of the second ladder segment through a space between the elongated pillars of the second ladder segment.

23. The method of claim 20, further comprising lifting the first and second ladder segments by lifting one of the foothold beams.

24. The method of claim 20, further comprising connecting a platform to at least one of the first and second ladder segments, the platform being configured to support a hunter when attached to an elevated position.
